(19) United States
(12) Patent Application Publication
(10) Pub. No.: US 2015/0375676 A1
(43) Pub. Date: Dec. 31, 2015

(54) BURIED INTERIOR LAMP FOR VEHICLE

(71) Applicant: Hyundai Motor Company, Seoul (KR)

(72) Inventor: Sung Cheul Jeong, Yongin (KR)

(21) Appl. No.: 14/531,342

(22) Filed: Nov. 3, 2014

(30) Foreign Application Priority Data
Jun. 26, 2014 (KR) 10-2014-0078766

(51) Int. Cl. B60Q 3/02

(52) U.S. Cl. CPC B60Q 3/0203; B60Q 2500/10

(57) ABSTRACT

A buried interior lamp of a vehicle includes: an illumination portion in which a light source for emitting light is disposed in a buried interior lamp of a vehicle which is inserted into and installed in a vehicle headlining; a pattern layer disposed on the lower portion of the illumination portion to form a specific design of light; a fabric layer disposed on the lower portion of the pattern layer; and a pattern cover layer which is disposed between the pattern layer and the fabric layer and has the same color as a cover so as not to display the pattern layer to the outside when turning off a lamp of the illumination portion.

### CROSS REFERENCE TO RELATED APPLICATION

The present application claims under 35 U.S.C. §119(a) the benefit of Korean Patent Application No. 10-2014-0078766, filed on Jun. 26, 2014, which is incorporated by reference herein in its entirety.

### BACKGROUND

(a) Technical Field

The present invention relates to a buried interior lamp for a vehicle, and more particularly, to a buried interior lamp in which a specific pattern is given to an interior decoration surface of the vehicle and a uniform illumination is shown when turning on the illumination lamp, although an outer appearance and shape of the illumination are not shown when turning off the lamp.

(b) Description of the Related Art

Generally, illumination in a vehicle has a problem in that bezel and lens portions of illumination are exposed to the outside and thus aesthetic unity of vehicle interior materials is deteriorated. In addition, in order to put a specific pattern to a general panel illumination for the purpose of improving commercial value, the pattern which uses a printing or a blind patch is disposed and achieved on an upper portion of the illumination, however the specific pattern is perceived due to a given specific design pattern even when turning off lights as well as turning on lights.

FIGS. 1 and 2 (RELATED ART) are cross-sectional views schematically illustrating a conventional interior lamp for a vehicle. Referring to FIG. 1, in the case of built-in illumination that is mounted in a vehicle, an outer plastic lens 40 such as PC and PMMA are separately mounted together with a bezel 30 in addition to a light-emitting portion 20 of illuminations such as a bulb or LED. The outer plastic lens 40 serves to prevent diffusion of point illumination or the light-emitting portion of illumination from being exposed. In the related art, even though the outer plastic lens is suitable for the basic performance of illumination which lights the interior, there is a disadvantage that the outer plastic lens 40 is exposed to the outside to obstruct an aesthetic appearance of vehicle interior materials. For example, in the case of an interior lamp cover mounted on a headlining of a vehicle, it has a different color from that of the headlining, and thus causes disharmony and protrudes toward the lower end portion when being observed and thereby obstructs the aesthetic appearance.

Meanwhile, referring to FIG. 2, built-in illumination of a vehicle generally performs a role of lighting a target in a vehicle. However, in order for a lamp itself to be used as a mood lamp which performs the role of an ornament, it is necessary to assign a function having a specific pattern rather than a form of general panel illumination. To this end, even though a method of assigning a design to the plastic lens is generally used, the plastic lens is made of transparent or semi-transparent material, and thus has a limit to assigning a pattern. Another method of assigning a pattern to the plastic is to form a printing pattern portion 50 on the plastic lens portion 40. For example, this method is based on a principle of achieving the pattern through a difference in the degree of light transmission between the printing pattern portion 50 and a non-pattern portion when turning on a light. However, this method has a problem in that a pattern is perceived by consumers even when turning off a light, although it is possible to effectively achieve the pattern when turning on the light, thereby obstructing the aesthetic appearance of the interior materials. The description provided above as a related art of the present invention is just for helping in understanding the background of the present invention and should not be construed as being included in the related art known by those skilled in the art.

### SUMMARY

The present invention provides a buried interior lamp of a vehicle in which a specific design is not perceived since it is covered by a internally mounted-fabric when turning off the lamp, thereby maintaining a uniform design, whereas the specific design is shown when turning on the lamp.

In one aspect, the present invention provides a buried interior lamp of a vehicle, including: an illumination portion in which a light source for emitting light is disposed; a pattern layer disposed on the lower portion of the illumination portion to form a specific design of light; a fiber layer disposed on the lower portion of the pattern layer; and a pattern cover layer which is disposed between the pattern layer and the fabric layer and has colors indistinguishable from colors of a cover so as not to display the pattern layer to the outside when turning off lights of the illumination portion. In particular, the colors of the pattern color layer are indistinguishable from those of a cover, thus obscuring the pattern layer, such that a user would not be able to perceive the pattern layer when the illumination portion is turned off.

The pattern layer may form a specific design by forming an impenetrable coating layer on a transparent film. The pattern cover layer may include a cover coating layer that is formed in the same pattern as the impenetrable coating layer on a transparent film.

The impenetrable coating layer may be printed with a coating agent containing a thermo-hardening urethane resin, a carbon black-based inorganic pigment, a cyclohexanone, a defoaming agent, a dispersing agent, and a thinner.

The pattern cover layer may be printed with a coating agent containing an organic pigment having the same color as a thermo-hardening urethane resin and a fiber layer, a cyclohexanone, a defoaming agent, a dispersing agent, and a thinner.

### BRIEF DESCRIPTION OF THE DRAWINGS

The above and other features of the present invention will now be described in detail with reference to exemplary embodiments thereof illustrating the accompanying drawings which are given herein below by way of illustration only, and thus are not limitative of the present invention, and wherein:

FIG. 1 (RELATED ART) is a cross-sectional view illustrating schematically an interior lamp for a vehicle according to the related art;

FIG. 2 (RELATED ART) is a cross-sectional view illustrating schematically showing another interior lamp for a vehicle according to the related art;

FIG. 3 is a cross-sectional view illustrating a buried interior lamp for a vehicle according to an embodiment of the present invention; and

FIG. 4 is a view illustrating whether patterns are perceived outside when (a) turning off and (b) turning on a buried interior lamp for a vehicle according to the embodiment of the present invention.

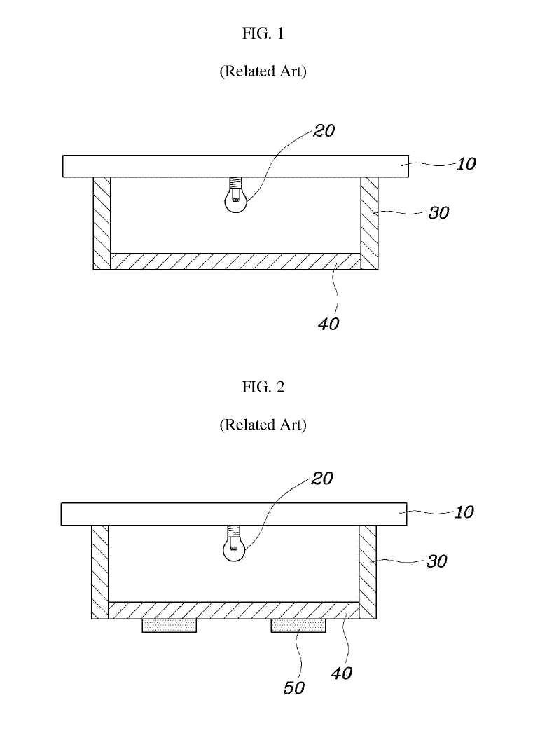

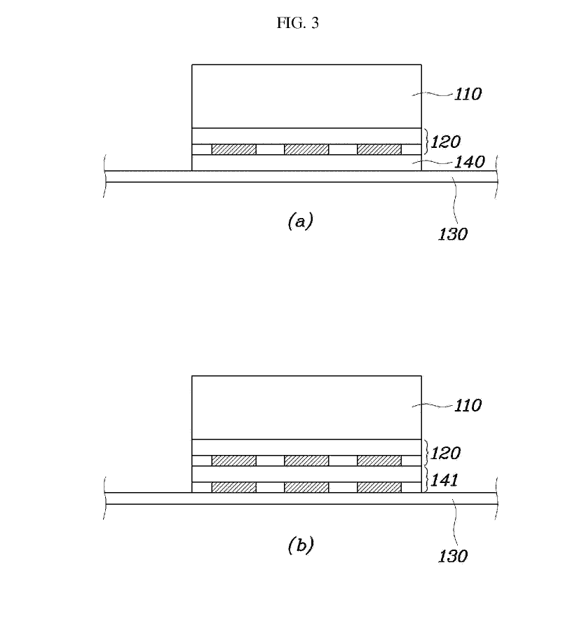

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover the exemplary embodiments as well as various alternatives, modifications, equivalents and other embodiments; which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, a buried interior lamp for a vehicle according to a preferred embodiment of the present invention is described with reference to the accompanying drawings.

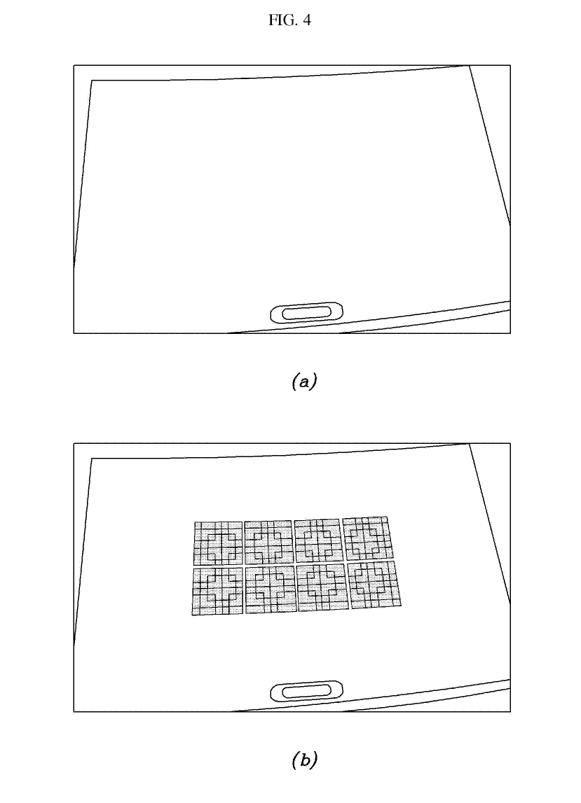

FIG. 3 is a cross-sectional view of a buried interior lamp for a vehicle according to an embodiment of the present invention. Referring to FIG. 3, a buried interior lamp for a vehicle may include an illumination portion 110, a pattern layer 120, a fabric layer 130, and pattern cover layers 140, 141.

The illumination portion 110 is buried toward the inside of a headlining of a vehicle, and a light source such as a bulb or LED may be installed therein. The light from the illumination portion may light the interior of a vehicle downwardly. Further, predetermined shapes of patterns may be formed on the pattern layer 120 so as to illuminate specific designs using light from the illumination portion 110. Such patterns have a light transmission rate of about 5% or less and the light can transmit through the portion where the patterns are not formed and form a predetermined design of pattern on the interior of a vehicle, thereby improving the aesthetic appearance.

The pattern layer 120 may be made by forming an opaque coating layer using coating materials on transparent film materials such as PET and PC through inkjet and screen printings.

The fabric layer 130 may be configured such that an interior lamp for a vehicle according to the present invention is installed inside a headlining so as to be able to be covered entirely together with the vehicle headlining, and may be made of the same fabric as interior materials of the vehicle. The lights emitted out of the illumination portion through the fabric layer may be able to illuminate the interior of a vehicle.

Since lights may transmit through a fabric layer when the illumination portion is turned off, the pattern layer disposed inside may be reflected on the fabric layer, thereby obstructing the aesthetic appearance of an interior of the vehicle.

The pattern cover layers 140, 141 may be disposed between the fabric layer and the pattern layer to maintain the aesthetic appearance of interior of a vehicle even when the illumination portion is turned off. The pattern cover layers may have colors indistinguishable from the fabric layer with the naked eye so as to obscure the pattern layer, such that a user would not be able to perceive the pattern layer when the illumination portion is turned off. The pattern cover layer may be entirely formed as one layer 140 so as to correspond to the area of upper portion of the illumination portion, and may be formed by forming cover coating layers on transparent film as a pattern cover layer 141 so as to have the same pattern as a pattern layer 120 in order to improve the reduction of brightness of the fabric layer.

The buried interior lamp of a vehicle may be installed anywhere inside the vehicle and the position is not limited to a headlining portion as described in the present specification.

FIG. 4 is a view illustrating whether patterns are perceived from the outside when (a) turning off and (b) turning on a buried interior lamp of a vehicle according to an embodiment of the present invention. As shown in FIG. 4, when turning off the lamp, a pattern layer on the inside is not perceived from the outside so as to maintain a uniform aesthetic appearance of the interior. Whereas it can be seen that a design formed by the pattern layer may be distinctly perceived when turning on the lamp.

Hereinafter, more detailed description will be made through embodiments.

### EMBODIMENT 1

A pattern layer is formed by printing a coating agent manufactured by mixing a thermo-hardening urethane resin of 35 parts by weight, a carbon black-based inorganic pigment of 10 parts by weight, a cyclohexanone of 50 parts by weight as a solvent, and an additive of 5 parts by weight containing a defoaming agent, a dispersing agent, and a thinner to a transparent PET film (Skyrol®125 μm produced by SKC, Korea) on a screen to form window and door patterns, and drying it at 110° C. for 60 minutes.

A pattern cover layer is manufactured by printing a coating agent manufactured by mixing a thermo-hardening urethane resin of 35 parts by weight, an organic pigment of 10 parts by weight having the same color as a fabric layer, a cyclohexanone of 50 parts by weight as a solvent, and an additive of 5 parts by weight containing a defoaming agent, a dispersing agent, and a thinner to a transparent PET film (Skyrol®125 μm produced by SKC, Korea) on a screen in the same shape as window and door patterns of the pattern layer, and drying it at 110° C. for 60 minutes.

A bonding agent (OCA produced by 3M) made of transparent materials is bonded on the manufactured pattern layer using a roll laminator heated at 50° C., and a pattern cover layer is bonded using a roll laminator heated at 50° C. after having removed a protect paper. After having applied a bonding agent on around edge of the illumination portion, the bonded pattern layer/pattern cover layer is bonded thereto, and is finally covered using a fabric used to a headlining of a vehicle.

### EMBODIMENT 2

A pattern layer is formed by printing a coating agent manufactured by mixing a thermo-hardening urethane resin of 35 parts by weight, a carbon black-based inorganic pigment of 3 parts by weight, a cyclohexanone of 50 parts by weight as a solvent, and an additive of 5 parts by weight containing a defoaming agent, a dispersing agent, and a thinner to a transparent PET film (Skyrol®125 _{μ}m produced by SKC, Korea) on a screen to form window and door patterns, and drying it at 110° C. for 60 minutes.

A pattern cover layer is manufactured by printing a coating agent manufactured by mixing a thermo-hardening urethane resin of 35 parts by weight, an organic pigment of 10 parts by weight having the same color as a fabric layer, a cyclohexanone of 50 parts by weight as a solvent, and an additive of 5 parts by weight containing a defoaming agent, a dispersing agent, and a thinner to a transparent PET film (Skyrol®125 μm produced by SKC, Korea) on a screen in the same shape as window and door patterns of the pattern layer, and drying it at 110° C. for 60 minutes.

A bonding agent (OCA produced by 3M) made of transparent materials is bonded on the manufactured pattern layer using a roll laminator heated at 50° C., and a patter cover layer is bonded using a roll laminator heated at 50° C. after having removed a protect paper. After having applied a bonding agent around edge of the illumination portion, the bonded pattern layer/pattern cover layer is bonded thereto, and is finally covered using a fabric used to a headlining of a vehicle.

### COMPARATIVE EXAMPLE 1

A pattern layer is formed by printing a coating agent manufactured by mixing a thermo-hardening urethane resin of 35 parts by weight, a carbon black-based inorganic pigment of 10 parts by weight, a cyclohexanone of 50 parts by weight as a solvent, and an additive of 5 parts by weight containing a defoaming agent, a dispersing agent, and a thinner to a transparent PET film (Skyrol®125 μm produced by SKC, Korea) on a screen to form window and door patterns, and drying it at 110° C. for 60 minutes. After having applying a bonding agent around edge of the illumination portion, the formed pattern layer is bonded thereto, and then is finally covered using a fabric used to a headlining of a vehicle.

In regard to three kinds of test pieces, the testing result of pattern recognition from the outside when turning off the lamp is shown in Table 1.

TABLE 1

| | | | Comparative |
|---|---|---|---|
| | Embodiment 1 | Embodiment 2 | Example 1 |
| Whether patterns are | Excellent | Normal | Excellent |
| perceived when turning | | | |
| on lamp | | | |
| Whether patterns are | Not | Not | Strongly |
| perceived when turning | perceived | perceived | perceived |
| off lamp | | | |

From Embodiment 2 in which the light transmission rate of a pattern layer is increased by lowering the content of a carbon black-based pigment, it can be verified that the pattern layer is not perceived from the outside due to a pattern cover layer when turning off lamp as compared to Embodiment 1, whereas the light transmission rate of the pattern layer is higher, so the degree of perceiving the pattern when turning on lamp is lower as compared to Embodiment 1.

From Comparative Example 1 in which the pattern cover layer is not formed, it can be verified that the cover layer is reflect to the outside of a fabric layer when turning off lamp and thus the pattern is perceived from the outside as compared to Embodiment 1.

According to the buried interior lamp of the present invention, a user cannot perceive whether there is the lamp on the inside of a vehicle when turning off the lamp, however, an illumination state to which a predetermined pattern is given can be implemented when turning on the lamp.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A buried interior lamp of a vehicle, comprising:
an illumination portion in which a light source for emitting light is disposed;
a pattern layer disposed on the lower portion of the illumination portion to form a specific design of light;
a fabric layer disposed on the lower portion of the pattern layer; and
a pattern cover layer which is disposed between the pattern layer and the fabric layer and has colors indistinguishable from colors of a cover so as not to display the pattern layer to the outside when turning off lamp of the illumination portion.

2. The buried interior lamp of a vehicle of claim 1, wherein the pattern layer forms a specific design by forming an opaque coating layer on a transparent film.

3. The buried interior lamp of a vehicle of claim 2, wherein the pattern cover layer is formed by forming a cover coating layer in the same pattern as the opaque coating layer on the transparent film.

4. The buried interior lamp of a vehicle of claim 2, wherein the opaque coating layer is printed with a coating agent containing a thermo-hardening urethane resin, a carbon black-based inorganic pigment, a cyclohexanone, a defoaming agent, a dispersing agent, and a thinner.

5. The buried interior lamp of a vehicle of claim 3, wherein the pattern cover layer is printed with a coating agent containing a thermo-hardening urethane resin, an organic pigment having the same color as a fabric layer, a cyclohexanone, a defoaming agent, a dispersing agent, and a thinner.
